(19) United States
(12) Patent Application Publication
(10) Pub. No.: US 2004/0049958 A1
(43) Pub. Date: Mar. 18, 2004

(54) Device for displaying information and method of producing it

(76) Inventors: Ewald Eisen, Heidenheim (DE); Christian Blank, Tautkirchen (DE); Andreas Mahr, Munich (DE); Gerd Zimmermann, Munich (DE)

Correspondence Address: B Todd Patterson, Moser Patterson & Sheridan, Suite 1500, 3040 Post Oak Blvd, Houston, TX, 77056, US

(21) Appl. No.: 10/398,986

(22) PCT Filed: Oct. 10, 2001
(86) PCT No.: PCT/EP01/11711

(30) Foreign Application Priority Data
Oct. 10, 2000 (EP) 00122020.1

(51) Int. Cl. G09F 11/18

(52) U.S. Cl. 40/514

(57) ABSTRACT

The invention provides a flexible sheet for presentation of information, whereby said flexible sheet (2) comprises a self-winding portion (4). The flexible sheet (2) further comprises at least one handling section (6) for unwinding said flexible sheet (2). Furthermore, a method of producing a flexible sheet (2) is provided.

### FIELD OF THE INVENTION

The invention relates to an apparatus for presenting information and a method of producing the apparatus. In particular, this invention relates to a banner used by fans. More particular the present invention relates to a self winding sheet which is used to present information e.g. messages, images etc. and a method of producing it.

### BACKGROUND OF THE INVENTION

Information carriers are extensively used throughout society. Advertisement, warnings, fan support in sports events, political rallies or concerts. They may be used for providing people with information or for getting their attention. In most cases, pictures, messages, colors etc. are put on a big flat screen which is placed so that a lot of people see it.

In some cases, it is preferred to use a portable information carrier. For comfort of use, the carrier is rolled for easy transport. When needed, the carrier is unrolled and displayed. Such information carriers usually comprise a housing with some kind of winding mechanism onto which the information carrier can be rolled. The winding mechanism can be e.g. spring biased to urge the carrier into a retracted position. For display, the mechanism is unrolled. Often, a handle is provided at one end of the information carrier. The handle allows the user to easily grasp the carrier and extend it from the housing. Further, it prevents a complete retraction of the carrier into the housing.

Portable information carriers can be used, for example, in sporting events such as soccer, football, basketball, Olympic games etc. They serve to support a specific person, group or nation. In most instances, messages, text or pictures are used to cheer them or to celebrate them. Similar situations arise in pop concerts or political rallies, where affection and support is also demonstrated. Other information carriers are primarily used for advertisement campaigns, at sales points or for presenting maps.

Information carriers of the above kind are known in the art. In WO 93/23838 a ski pole trail map holder is disclosed. In one form, the holder comprises a tubular housing having a spring biased roller therein. The housing is attachable to the ski pole and the map is extendable from a retracted position in which it is rolled into the housing. Another device for the presentation of maps is described in DE 28 51 386.

A point of sale device is shown in UK 2 267 988. The device has a housing containing a spool. A blind 18 has one end attached to the spool and passes through an elongated slot in the housing and carries a stiffening strip on its other end. The strip is serving as a handle to enable the blind to be drawn from the spool. The spool is spring loaded by a coil spring one end of which is secured relative to the housing whilst the other end is rotates about the spring axis as the blind is drawn out of the housing.

Another information carrier used for advertisement campaigns or post cards is disclosed in Utility Model DE 298 00 807 U1. It comprises a winding rod. One end of which is connected to paper which, in it retracted position, is rolled onto the winding rod. A grip a the other end of the paper is used for unwinding the paper from the winding rod.

The above disclosed information carriers all have the disadvantage of being built sturdy so the information carrier can be used over a long period of time without breaking down. This renders the information carrier impractical; it is heavy, hard and tedious to carry.

The hardness and heaviness of the carrier can become, in particular at sporting events and political rallies, a severe problem. Not each visitor or fan is always happy with the performance of the team, group or individual he supports. Further, in case the event also includes the participation of an opponent, the fan of one side might also carry some negative feelings with respect to the other side or even their supporters. Some people get very emotionally involved to the point that they start throwing things either on their team, the opponents or randomly into the crowd. The impact of such an information carrier when it hits a human or obstacle can cause severe injuries or damage.

This problem has been recognized and addressed in WO 00/48164. It was attempted to reduce the weight of the housing or to provide the housing with a protective soft cover in order to lower the risk of injuries or damages. The costs, however, of incorporating these safety mechanism whilst maintaining reliable usage of the information carrier are very high.

### SUMMARY OF THE INVENTION

The present invention intends to provide an improved apparatus for the presentation of information with reduced costs and higher security. According to one aspect of the present invention, there is provided an apparatus as specified in independent claim 1. According to another aspect of the invention, there is provided an apparatus as specified in independent claim 2.

It is a further object of the present invention to provide a method of producing an improved apparatus for the presentation of information. According to a further aspect of the invention, there is provided a method as specified in independent claim 9. According to another aspect of the present invention, there is provided a method as specified in independent claim 10. According to still another aspect of the invention, there is provided a method as specified in independent claim 11. According to a further aspect of the present invention, there is provided a method as specified in independent claim 12.

By using a flexible sheet which comprises self-winding portions or portions with a strong tnedency to roll up, a housing is not required anymore. The soft and flexible banner according to the invention can easily be carried in a cloth pocket. There is no need to carry it in separate bags. Also, it adapts to a certain extend to the pocket shape without losing its function. The user does not feel discomfort by having the banner in a pocket close to his body. Further, even if the banner is thrown into a crowd of people, the risk of injuries is greatly reduced with respect to fan banners known in the state of the art.

Further advantageous, features, aspects and details of the invention are evident from the dependent claims, the description and the accompanying drawings. The claims are intended to be understood as a first non-limiting approach of defining the invention in general terms.

The dimensions of the flexible information carrier is, in principal, not critical. It will be preferred to use an elongated shape which is similar to the shape of a fan scarf which is commonly in use among fans. The height of the flexible sheet should be sufficient enough to allow the printing of big letters on them so that the message can be read from greater distances. The average distance between the receiver of the message and the fan will vary with respect to the specific event, may it be a sporting event such as soccer, boxing, bicycling, a political rally, a concert, or even stating a warning due to a car accident. The length should be chosen so that the user can easily wind an unwind the banner by stretching and retracting his arms across the chest.

According to the invention, the flexible sheet comprises two self-winding portions. A self-winding portion, in the context of this application, includes any kind of structure being capable of providing or promoting a self-rolling movement of the flexible sheet. The self-winding portion may be part of the flexible sheet itself Alternatively, it may be attached to it in any possible way e.g. by laminating, gluing, stitching, or by placing it in pockets etc.

According to one advantageous aspect of the invention, the self-winding portion comprises at least one self winding strip. The self winding strip allows easy extension of the information carrier and reliably retracts the information carrier back into a roll. Preferably, this strip extends along the winding direction of the information carrier.

According to a further aspect of the invention, the flexible sheet comprises two sections with self-winding portions. The self-winding portions in the two sections are arranged in such a way that both sections wind in opposite directions. This allows for an even and smooth extension and retraction of the information carrier in two directions.

According to still another aspect of the present invention, the self-winding portion comprises at least one prestressed layer. According to an other preferred aspect, the self-winding portion comprises a leaf or flat spring rolled into a spiral.

According to another preferred aspect of the present invention, the prestressed layer is subject to high stress. A further layer to which the prestressed layer is bonded, is subject to stress lower than that of the prestressed layer. This again allows a smooth and even winding and unwinding movement of the information carrier.

According to a further preferred aspect, the layers of the flexible sheet are made of polyethylene and/or polyester. According to an especially preferred aspect of the present invention, one layer of the flexible sheet is made of polyethylene and one layer of the flexible sheet is made of polyester.

According to a further preferred aspect, the prestressed layer is divided. One part is placed on one side of the flexible sheet and the other part is placed on the other side of the sheet. This again allows a smooth and even winding and unwinding movement of the information carrier.

According to a further preferred aspect, the leaf or flat spring is divided. One part is turned around and attached in longitudinal extension to the other part to the flexible sheet. This again allows a smooth and even winding and unwinding movement of the information carrier.

According to a further preferred aspect, at least one stabilizer is attached to the flexible sheet at a position between the two self-winding portions. This again allows a smooth and even winding and unwinding movement of the information carrier without deteriorating the flexibility of the sheet.

According to a further preferred aspect, at least one handling grip is attached to the flexible sheet. This allows for easy winding and unwinding of the information carrier.

According to a further preferred aspect, at least on one surface of the flexible sheet detachable thin foils are attached. Especially, printed foils are preferred. This allows for showing different texts or images on the same surface of the information carrier.

According to a further aspect of the invention, the flexible sheet is produced by a method comprising the steps of

a) bonding at least two layers, wherein one of the layers is prestressed;

b) cutting the bonded films along a lateral direction to obtain self-winding portions;

c) bonding two self-winding portions, wherein the prestressed surface of one portion faces in a direction opposite to the prestressed surface of the other portion.

According to an other aspect of the present invention, a method for producing a flexible sheet is provided which comprises the following steps:

a) bonding at least two layers, wherein the first and the second layer comprise portions subject to high and low stress in an alternating manner, and wherein a portion of the first layer subject to high stress is bonded to a portion of the second layer subject to low stress and vice versa;

b) cutting the bonded layers at distal ends along a lateral direction, wherein a sheet to be cut comprises portions subject to high and low stress of the first and the second layers.

According to a further preferred aspect of the invention, the alternating portions subject to high and low stress of the first and second layers are obtained by controlling the rotational speed of the feed rollers for the first and second layers, respectively. This allows for efficient and low cost production of flexible sheets.

According to still another aspect of the present invention, a method for producing a flexible sheet is provided which comprises the following steps:

a) bonding at least two layers, wherein one of the layers is prestressed;

b) supplying two rolls of layers bonded according to step a) to a bonding region of a bonding machine, wherein the prestressed surface of a first layer faces a direction opposite to that of the prestressed surface of a second layer,

c) bonding a front portion of the first layer to an end portion of the second layer;

d) cutting the first layer at a distal end of the front portion along a lateral direction and cutting the second layer directly at the bonded end portion;

e) ejecting the obtained flexible sheet from the bonding machine;

According to a further aspect of the present invention, a method for producing a flexible sheet is provided which comprises the following steps:

a) bonding at least two layers, wherein one of the layers is prestressed;

b) supplying two rolls of layers bonded according to step a) to a bonding region of a bonding machine, wherein the prestressed surface of a first layer faces a direction opposite to that of the prestressed surface of a second layer,

c) bonding a bonding portion of the first layer to a bonding portion of the second layer,

d) cutting out between the bonding portions a portion of the first and second layer, respectively, in an alternating manner.

According to a further preferred aspect of the invention, the layers used in a method for producing a flexible sheet are made of polyethylene and/or polyester.

The invention is also directed to methods by which the described apparatus operates. It includes method steps for carrying out every function of the apparatus. Furthermore, the invention is also directed to an apparatus for carrying out the disclosed methods and including apparatus parts for performing each described method steps. These method steps may be performed by way of hardware components, a computer programmed by appropriate software, by any combination of the two or in any other manner.

### BRIEF DESCRIPTION OF THE DRAWINGS

Some of the above indicated and other more detailed aspects of the invention will be described in the following description and partially illustrated with reference to the figures. Therein:

FIG. 1 shows a top view of a portion of a flexible sheet comprising a self-winding portion according to the invention.

FIG. 2 show side views of embodiments according to the invention.

FIG. 3 show side views of embodiments according to the invention with a separated self-winding portion.

FIG. 4 show several possible shapes of embodiments according to the invention.

FIG. 5 shows an embodiment according to the invention with one self winding strip.

FIG. 6 shows an embodiment according to the invention with two self winding strips.

FIG. 7 shows an embodiment according to the invention with two self winding strips, the self-winding portion being separated.

FIG. 8 show several ways of fixing or incorporating the self-winding portions.

FIG. 9 shows an embodiment of the invention with a self-winding portion covering the complete flexible sheet.

FIG. 10 shows an embodiment of the invention with a self-winding portion covering the complete flexible sheet, the self-winding portion being separated.

FIG. 11 shows an embodiment of the invention with a self-winding portion covering the complete flexible sheet, the flexible sheet being separated.

FIG. 12 shows the winding movement of an embodiment according to the invention comprising two sections with opposite winding directions.

FIG. 13 shows a leaf spring being attached to a grip.

FIG. 14 show several sheets with a variety of end sections comprising grips or not comprising grips.

FIG. 15 shows a method of producing a flexible sheet according to an embodiment of the present invention.

FIG. 16 shows a method of producing a flexible sheet according to a further embodiment of the present invention.

FIG. 17 shows a method of producing a flexible sheet according to a further embodiment of the present invention.

### DESCRIPTION OF THE PREFERRED EMBODIMENTS

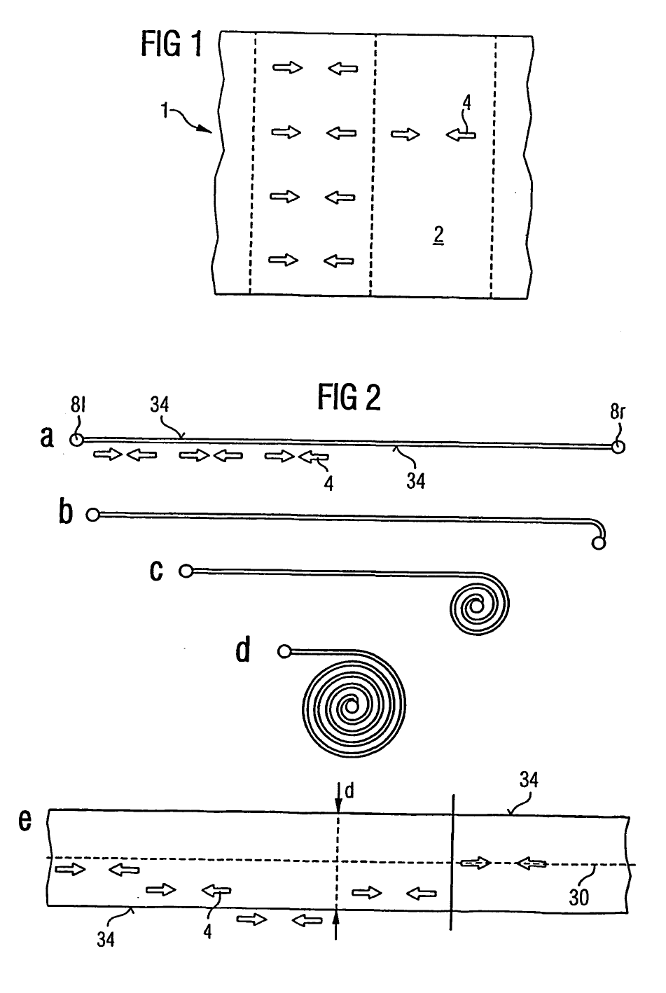

A partial top view of an embodiment according to the invention is shown schematically in FIG. 1. The flexible sheet 2 of the fan banner 1, a section of which is shown, comprises a self-winding portion 4 distributed over the flexible sheet. The two arrows pointing towards each other represent the forces acting on the flexible sheet. In the figure, the flexible sheet is subdivided into several sub sections by dotted lines extending over the complete height of the banner. Two of this sub sections are shown in FIG. 1. This subdivision is not a real division of sheet 2, it only serves to better understand the principle of the present invention. The forces preferably act only on one side of the flexible sheet e.g. the top side (see also FIG. 2a) there are no forces acting on the other side, here the bottom side, of flexible sheet 2. Within one subsection, these forces have the tendency of pulling the outer edges of each subdivision towards each other since they act only on one surface of the sheet (the outer edges of the subdivisions are located adjacent to the dotted lines). This results in a rolling movement of flexible sheet 2 within the respective subsection and, since all of the subsections experience the same forces, in a self-winding or rolling up movement of those parts of flexible sheet 2 which comprise self-winding portions 4. Thereby, it is not necessary that the self-winding portion always completely covers a subsection from top to bottom. There only needs to be a sufficiently large self-winding portion in some or all subsections to cause enough winding tendencies for the whole information carrier to roll up.

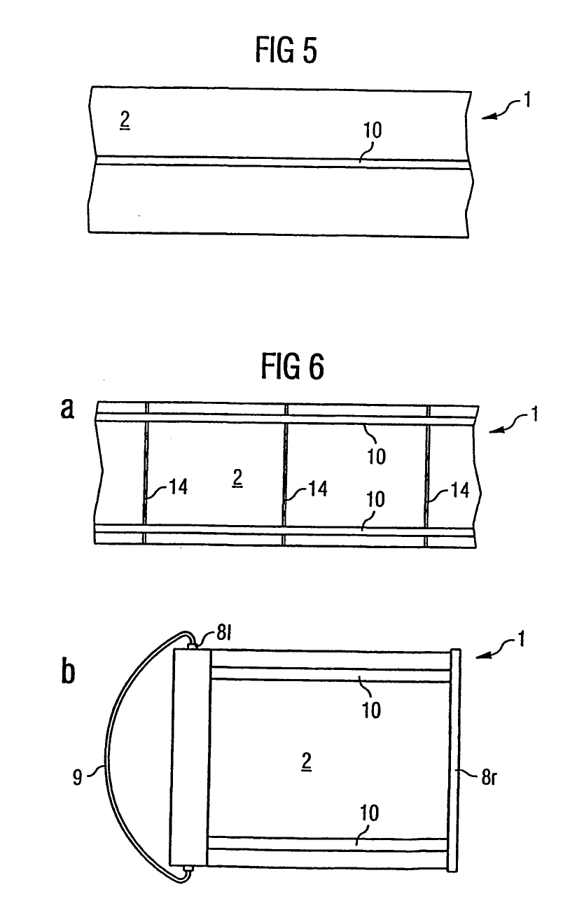

FIG. 2 show side views of information carriers illustrating the winding movement. In FIG. 2a, self-winding portions 4 act on one side of flexible sheet 2, here the lower side of flexible sheet 2. Both sides, the top and the lower side of flexible sheet 2 can act as display side 34. If the user would release-grip 8r on the right side of the information carrier and grip 8l on the left side is unmoved, the right side of banner 1 starts to wind. This winding movement is indicated through FIGS. 2b to 2d. The winding movement of the embodiment shown in FIG. 6b differs from that described in with respect to FIGS. 2b to 2d. In the embodiment shown in FIG. 6b, the longest part of flexible sheet 2 is already wrapped around grip 8l. Grip 8l mainly comprises a hollow tube to which flexible sheet 2 is attached. Bow grip 9 has a bow shaped handle and a straight axis connecting the two end sections of the bow shaped handle. The straight axis runs through the hollow tube of grip 8l within which it can freely rotate. If grip 8r is moved to the left, the self-winding portions of the information carrier will cause flexible sheet 2 to wrap around grip 8l which in turn rotates about the straight axis of bow grip 9. By moving grip 8r back to the right, grip 8l rotates in the opposite direction and flexible sheet 2 is extended to a display position. This arrangement will allow for easy un- and up-winding of the information carrier.

In FIGS. 2e and f, several ways of locating self-winding portions 4 with respect to flexible sheet 2 are demonstrated. Without limiting the scope of the invention to this embodiment, it is assumed that flexible sheet 2 maintains the same thickness d throughout its length. The dashed line running along the center of flexible sheet 2 indicates middle line 30. To achieve a smooth winding movement and depending on the self-winding portion used e.g. a prestressed layer, it is advantageous to locate all winding structures 4 on one side of the dashed line (right side). This assures that the whole sheet rolls in one direction. It depends on the materials used (flexible sheet, self-winding portions etc.) and on the desired winding force, to what extend self-winding portions 4 are spaced from middle line 30. If, for example, a prestressed layer is used as self-winding portion and if the prestressed layer would be located directly along middle line 30, it will cause the flexible sheet to fold or wrinkle instead of causing a rolling movement (left side). If the self-winding portion comprises a leaf spring which is shaped into a spiral, the location of the leaf spring with respect to flexible sheet 2 (or its middle line) is not important since flexible sheet 2 will follow the movement of the leaf spring independent of whether the leaf spring is arranged above or below flexible sheet 2 (not shown).

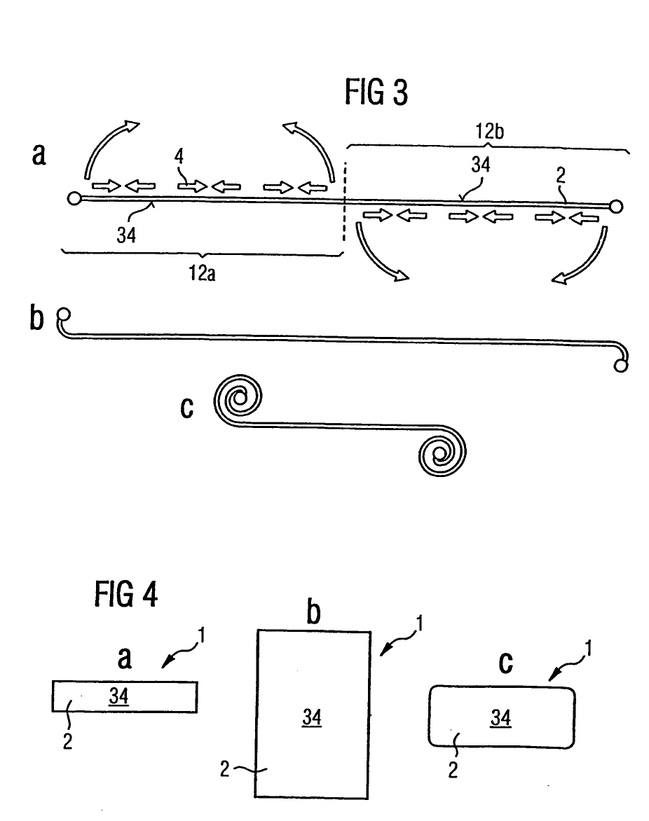

FIG. 3 shows further advantageous embodiments according to the invention. As in FIG. 2, flexible sheet 2 is shown in a side view. Especially, when used as a fan banner, images, messages, text etc. displayed on the sheet will be e.g. printed on its upper or lower display sides 34 which run perpendicular to the paper plane. The dashed line represents center line 32 of flexible sheet 2. In this context, the term center line refers to the half length of the complete length of flexible sheet 2 in its longitudinal direction. The center line divides flexible sheet 2 in a first and a second section. In this embodiment, self-winding portions 4 are not all acting on one side of flexible sheet 2. Some self-winding portions 4 are located in a first section 12a of flexible sheet 2 acting on one side of flexible sheet 2, other self-winding portions 4 are located in a second section acting on the other side of flexible sheet 2. Self-winding portions acting on one side of a flexible sheet, in this context, means to cause a rolling movement of this sheet so that this side is located on the inside of the rolled or bend sheet. This means with respect to FIG. 2, self-winding portion 4 acting on the bottom side of flexible sheet cause the sheet to roll downwardly, and with respect to FIG. 3, self-winding portion 4 acting on the top side of flexible sheet 2 in a first section 12a cause the sheet to roll upwardly in this section and self-winding portion 4 acting on the bottom side of flexible sheet 2 in a second section 12b causes the sheet to roll downwardly in this section. Thereby, it is not required that center line 32 is located exactly in the middle of the extended flexible sheet. Deviations from that position are still within the scope of the invention. For a smooth and symmetric use of the information carrier, the middle position or slight deviations from it, is however advantageous.

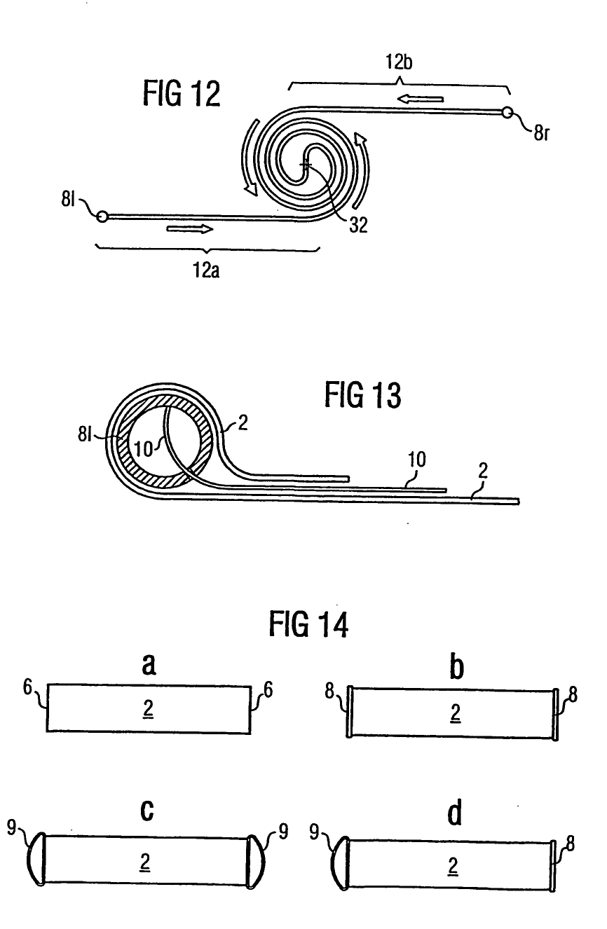

FIGS. 3b and c indicate the rolling movement of the information carrier when grips 8r to the right and 8l to the left of flexible sheet are released. Grip 8r starts to roll itself into the top plane of flexible sheet 2. The rolling movement of grip 8r will start on the right side and it will move towards the left. Grip 8l starts to roll itself into the lower plane of flexible sheet 2. The rolling movement of grip 8l will start to the left and it will move towards the right. An alternative rolling movement is shown in FIG. 12. Thereby, grips 8r and 8l are not released but steadily moved towards the center line 32 of flexible sheet 2. As demonstrated in FIG. 12, center line 32 will rotate counter-clockwise around its axis. Thereby, the first section 12a of flexible sheet 2 is rolled simultaneously and parallel to the second section 12b of flexible sheet 2. To unwind the information carrier again, grips 8r and 8l are steadily moved away form the center.

FIG. 4 show several shapes of information carriers in extended form. FIG. 3a is a longish banner similar to a scarf. A banner of this shape is advantageously held above the head. There, un- and up-winding of the banner is achieved e.g. by regularly stretching the straight arms. The other two information carriers with different shapes are mainly held in front of the body. In particular, the banner shown in 4b can be as high as a person. The width of the banner should not excessively exceed the length of two stretched arms so that the average user can easily extend it in front of his body. The banner shown in FIG. 4c has a length comparable to the length of banner 4a, however, with a higher height. This allows a better display of images. The banners are not required to have a rectangular shape. Their comers could be rounded or the whole banner could have a oval shape. In case the comers are rounded, the handling sections preferably located at the end sides of the banner advantageously comprise extended sections with a bow shaped end part to support the comers. Further, depending on how the self-winding portions are arranged, the banners can be extended in an either horizontal, vertical or diagonal direction. According to an advantageous embodiment, several detachable thin foils are layered over the flexible sheet of the information carrier. During an event, the top layer can be tom of so that the subsequent foil can be used for display. This way, a message story can be told.

In the following, samples of information carriers comprising self-winding portions are described. FIG. 5 shows a longish banner 1 comprising a flexible sheet 2 with one self-winding strip 10 extending along the length of the banner. The self-winding strip 10 does not need to extend along the complete length of the banner, however, preferably it does. In this embodiment, self-winding strip 10 is approximately arranged in the middle of banner 1. This is not required, strip 10 could also be located e.g. within the lower or upper half of the banner. An alternative embodiment with two strips is shown in FIG. 6a. One strip is located along the lower edge of banner 1, the other strip is located along the upper edge of banner 1. This provides the banner with a higher stability and allows a smoother extension and retraction of it. For further support of the flexible sheet, stabilizers 14 are preferably arranged perpendicular to the direction of extension. A thin rod made out of plastic or wood may serve as stabilizer 14. For security and comfort reasons, it is preferred to cover the rod with a soft material or to use a soft material e.g. a foam having enough stability to keep the banner stretched. When the banner is rolled up, stabilizer 14 rolls with ease into the banner since it has no extension along the winding direction.

Stabilizers 14 provide banner 1 with additional support so that flexible sheet 2 can serve to a large extend as display without having hanging or flapping sections. Stabilizers can be incorporated in all kinds of banners irrespective of their shape or the materials used for self-winding portions. If sturdy grips are used as handling sections 6, they simultaneously serve as stabilizers.

Self-winding portions, in particular strips 10 can be made out of different materials. One option is a flat or leaf spring 20. The spring is rolled into a spiral. If a pulling force is applied to the spring, it starts to stretch thereby storing energy. This energy is used to retract the spring into its original position after the pulling forces have ceased to act on it. In principle, any kind of elastic material can be used for the spring. Preferred material choices are metals and plastics.

Alternatively, a prestressed layer can be used for self-winding portion 4. A layer or strip of elastic material is extended and then attached onto flexible sheet 2. The elastic force of the prestressed layer acts on flexible sheet 2 and causes a winding movement. Thereby, flexible sheet 2 is preferably to be stable enough not to be folded or wrapped by prestressed layer 2. The rolling movement of the flexible sheet with an prestressed sheet attached to it is comparable with the rolling of a bimetal. In a bimetal, two layers of metal with different coefficients of thermal expansion are bonded together. If exposed to temperature other than room temperature, one metal layer expands more than the other thus exerting a force which cause the bimetal to curve. In the banner, the prestressed layer exerts a constant force on the flexible sheet thus causing it to roll if no counter force is keeping the banner in an extended state.

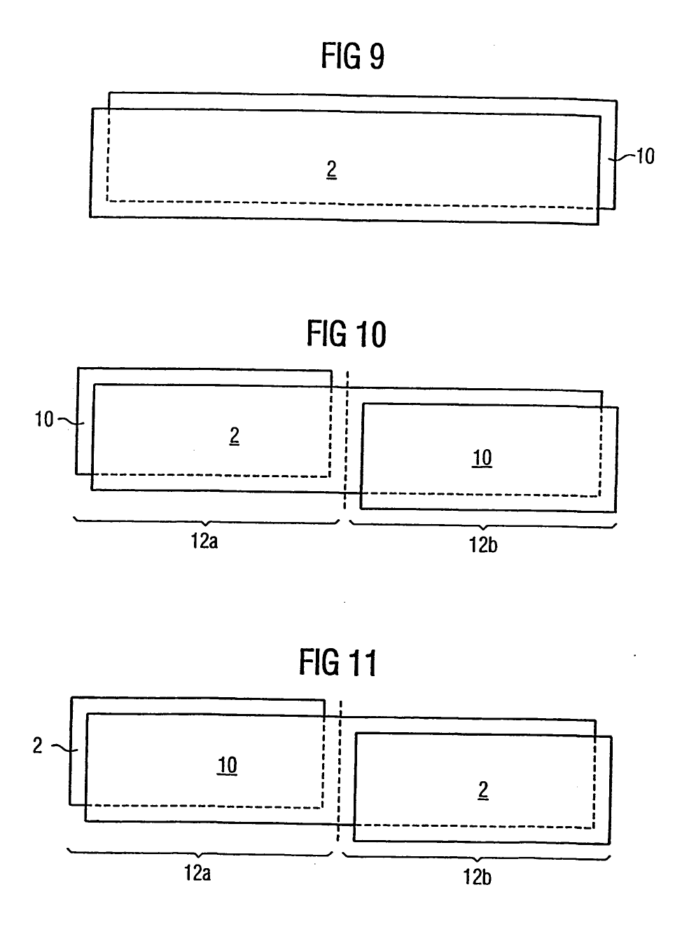

The self-winding portions e.g. leaf springs or prestressed layers can be arranged in several ways along flexible sheet 2. One option is to take a self-winding portion of same size and dimension as flexible sheet 2. The self-winding portion is then attached to flexible sheet 2. This way, winding forces are evenly distributed over the whole sheet Example are shown in FIGS. 9 and 10. In this embodiment, self-winding portions 4 are denoted with 10 and cover the whole flexible sheet 2. The embodiment of FIG. 10 shows a divided self-winding portion whereas the embodiment of FIG. 9 shows a self-winding portion without separation. If the self-winding portion covers flexible sheet 2 completely or to a large extent, as it is shown in the two embodiments of FIGS. 9 and 10, it is preferred to use prestressed layers. It allows for an easier production process and ensures good rolling qualities.

A further option is the use of self-winding strips 10 which do not cover all or most of flexible sheet 2. Respective embodiments are shown in FIGS. 5, 6 and 7. Here, the use of leaf springs is of advantage. Alternatively, several small strips (prestressed layerss or leaf springs) all extending in the same direction can be distributed at random across flexible sheet 2. This allows for an even rolling movement (a respective embodiment is not shown). The production process, however, for such a distribution of self-winding portions 4 is fairly involved.

FIG. 6b shows a banner comprising two elongated self winding strips. This banner unwinds itself in one direction, here to the right, over the complete length of its flexible sheet. In fact, one end section of the banner, grip 8l, is mostly located within the retracted roll. Only in a completely unrolled position, grip 8l is uncovered. Banner 1 is extended by taking grip 8r and pulling it to the right. At the same time, bow grip 9 can be pulled to the left. Grip 8l, which is formed as a hollow tube, freely rotates about the straight section of bow grip 9. Naturally, bow grip 9 can also be arranged at the right end of banner 1 and interact with grip 8r which then freely rotates. In this case, grip 8l is pulled to the left and bow grip 9 is pulled to the right. Further, it is possible to use a bow grip on both ends of banner 1.

Contrary to the above described embodiment, the banner shown in FIG. 7 comprises a self-winding portion with different winding properties in sections 12a and 12b. For ease of reference, without limiting the scope of the invention, it is assumed that section 12a winds into the space below the paper plane and section 12b winds into the space above the paper plane. To achieve this, self winding strips 10 are divided approximately at half length. They are attached to flexible sheet 2 in a manner to achieve opposite winding movements in both sections. For example, if a leaf spring is used, one leaf spring is rotated 180 degrees around its longitudinal axis before attaching it to flexible sheet 2. The two leaf springs meet at center line 32. Here, the leaf springs either overlap a short distance, about 0-2 cm, or a short space without leaf spring is left between them. A small overlap allows to directly connect the two leaf springs with each other. The rolling movement of banner 1 is described with reference to FIG. 12. This figure is obtained by rotating the banner shown in FIG. 7 around its longitudinal axis for 90 degrees. Thereby, the upper edge of the banner is moved up and the lower edge of the banner is moved down. In other words, when viewed along the axis of rotation from the right side, see arrow, the banner is rotated counterclockwise. By moving grips 8r and 8l towards center line 32 or by simply moving one grip towards center line 32 and keeping the other grip in its position, flexible sheet 2 winds itself counterclockwise around center line 32. This way, no bow grip with a straight section being capable of rotating in a hollow tube is needed since none of the grips 8r or 8l acts as center of rotation; the rotation is carried out around center line 32. When the banner is completely rolled, sections 12a and 12b of flexible sheet 2 will lay parallel to each other.

Instead of leaf springs, prestressed layers can be used to achieve the same effect. In the embodiment shown in FIG. 7, prestressed strips 10 in section 12a are attached to the lower side of banner 1. Prestressed strips 10 in section 12b are attached to the upper side of banner 1. This causes section 12a of flexible sheet 2 to wind into the space below the paper plane and section 12b winds into the space above the paper plane. Alternatively, the complete sections 12a and 12b can be covered with a prestressed layer. Such an embodiment is shown in FIG. 10. Prestressed layer 12 is attached to the lower or backside of flexible sheet 2 in section 12b and to the upper or front side of flexible sheet 2 in section 12a. Preferably, a stabilizer is arranged between sections 12a and 12b. The respective rolling movement of the above described embodiment is shown in FIG. 12.

An alternative embodiment is shown in FIG. 11. This embodiment has the same structure as the embodiment shown in FIG. 10, however, prestressed layer (or strip) 10 is sandwiched in between flexible sheets 2 of section 12a and flexible sheet 2 of section 12b. In this banner, flexible sheet 2 is separated and not self-winding portion 10. In the embodiment shown in FIG. 11, section 12b will wind below the paper plane and section 12a will wind above the paper plane. If the banner is rotated 90 degrees around its longitudinal axis (when viewed in the direction of the arrow), the respective rolling movement of this banner is also shown in FIG. 12.

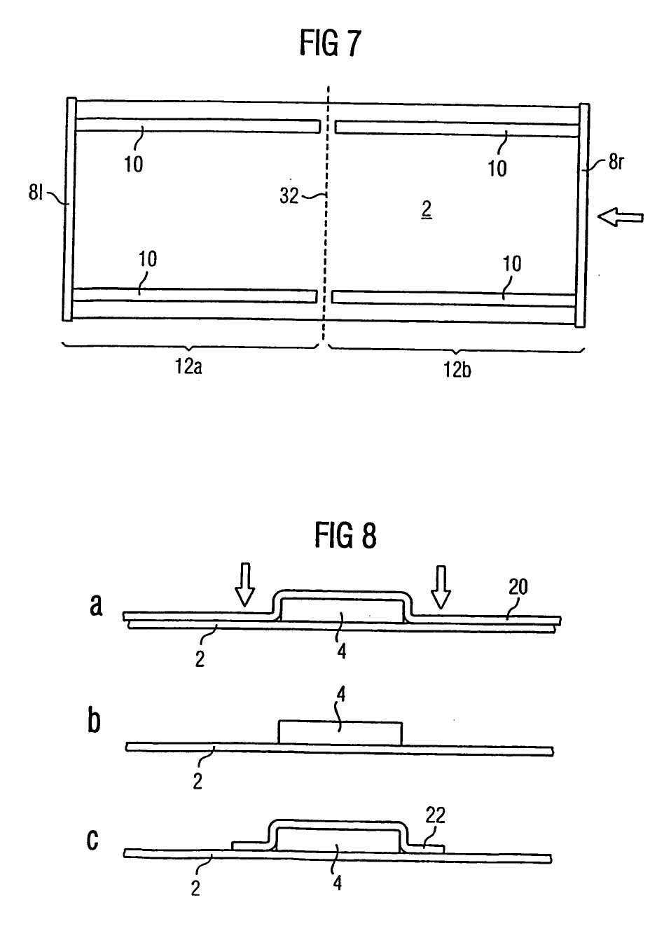

FIG. 8 demonstrate several ways of fixing self-winding portions to flexible sheet 2. In FIG. 8a a cover sheet 20 is placed over self-winding portion 4 and flexible sheet 2. Cover sheet 20 can be as large as flexible sheet 2. All kinds of laminating and fixing techniques can be applied to connect the two sheets together. Cover sheet 20 also needs to be flexible. In addition, stitches can be provided around self-winding portion 4 (see arrows). In particular, when a leaf spring is used, care should be taken to very securely fix the leaf spring so that it does not detach. In case a prestressed layer is used, stitches can also run through the prestressed sheet. FIG. 8b shows a self-winding portion directly attached to flexible sheet 2. This is preferably done with prestressed layers. In an alternative embodiment, a cover strip 22 is used instead of cover sheet 20. Cover strip 22 shown in FIG. 8c is slightly wider (and/or longer) than self-winding portion 4. The additional surface of cover strip 22 can be attached to flexible sheet 2. This way, a cover is only applied at locations where it is necessary to fix a self-winding portion.

FIG. 13 shows a grip connected to flexible sheet 2 in an embodiment which uses a leaf spring as self-winding portion. Grip 8l is a hollow tube with a longish slit in its wall. The slit is slightly higher than the height of leaf spring 10. The end of leaf spring 10 is inserted into the slit Inside the tube, the end of leaf spring 10 curves to the right due to its self winding force thereby preventing leaf spring 10 from sliding out of the tube again. Further fixation is achieved by rolling the end of flexible sheet 2 completely around grip 8l and attaching it to flexible sheet 2 again. This way, the tube of grip 8l is sealed into flexible sheet 2. For security, the tube of grip 8l is preferably filled up with filler material such as resin. This additional measurement further prevents leaf spring 10 from sliding out of the tube.

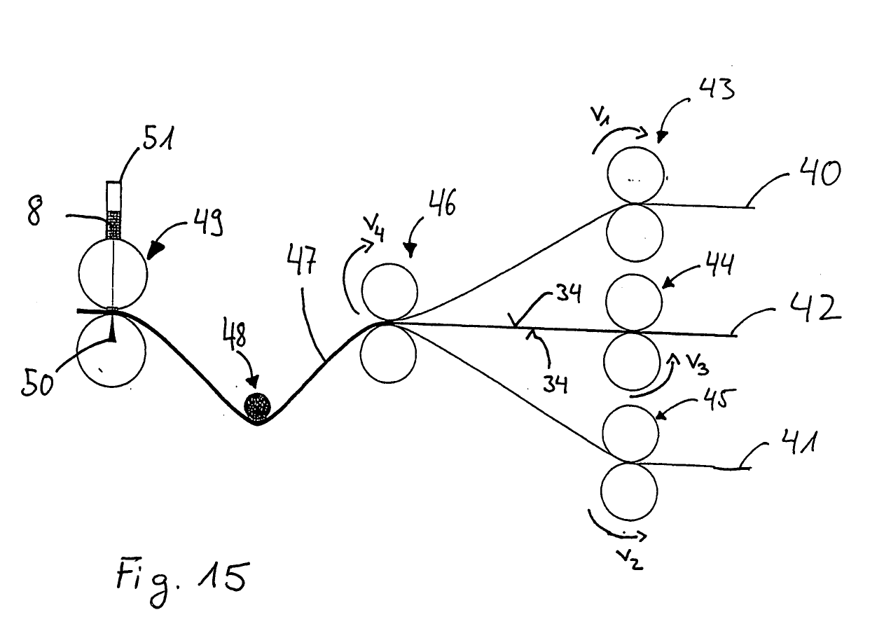

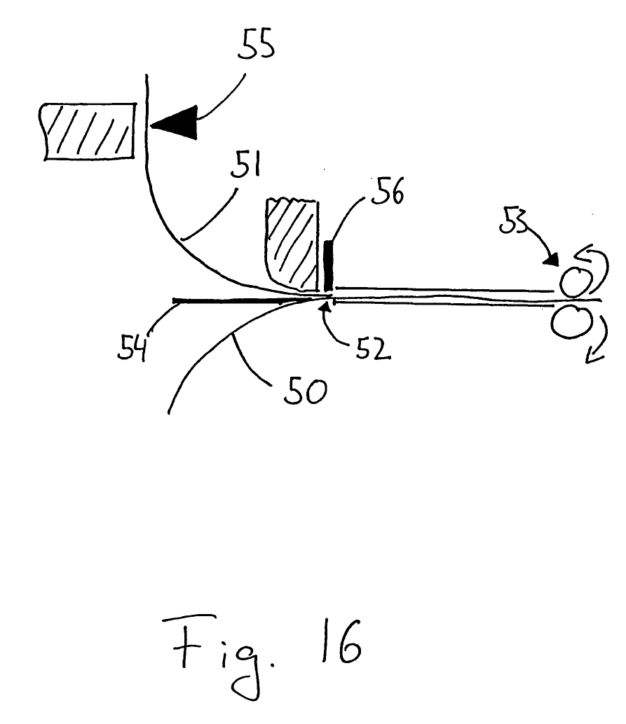

FIG. 14 show several embodiments of banners with a variety of handling sections or grips. FIG. 14a shows an extended fan banner with no grips attached to its ends. In this embodiment, the end sections of flexible sheet 2 serve as handling sections 6. The user grabs the end sections of flexible sheet 2 with his hands and pulls it. FIG. 14b shows the same embodiment with two grips 8 arranged at the end sections of flexible sheet 2. In general a straight rod, hollow or not, will do the job. It gives the user a better feel for the information carrrier than simply grabbing flexible sheet 2 directly with the hands. FIGS. 14c and 14d show embodiments with two bow grips 9 or one grip 8 and a bow grip 9. Depending on the system used for self-winding portions, the person skilled in the art will chose the proper combination. A bow grip is preferably used if flexible sheet 2 winds around a rotational part of this grip. If this is not the case, it is preferred to use a normal grip or no grip.

FIG. 15 shows a method of producing a flexible sheet according to an embodiment of the invention. A first layer 40, a second layer 41 and a third layer 42 are supplied to their respective feed rollers 43, 44, 45. Preferably, the first and second layers are transparent and the third layer is printed on its surfaces to from display sides 34. The three layers are fed to a feed roller 46, wherein they are bonded to each other 47. A pulley 48 stresses the bonded layers 47 before they are fed to a further feed roller 49. At the position of this further feed roller 49 a storage 51 for handling grips 8 is provided. Also, a ripping knife 50 for cutting the bonded layers 47 is provided. During the production process, the feed rollers 46 maintain a predetermined rotation speed v₄ for transporting the layers 40, 41, 42. The feed rollers 44 of the third layer rotate at a rotation speed v₃. Rotation speed v₃ is similar to v₄ so that the third layer 42 is not or only very softly stressed. The rotation speeds v₁, v₂ of the feed rollers 43, 45 for the first and second layers 40, 41 may be varied as described in the following: If the rotation speed v₁ of the feed roller 43 of the first layer 40 is similar to the rotation speed v₄ of the feed roller 46 for transportation the first layer 40 is subject only to low stress. In this context, low stress could even mean no stress at all. But if the rotation speed v₁ of the feed roller 43 of the first layer 40 is lower than the rotation speed v₄ of the feed roller 46 for transportation the first layer 40 is subject to high stress. The amount of stress applied to the first layer 40 corresponds to the speed difference v₄−v₁ of the respective feed rollers 46, 43. The above-stated applies also to the second layer 41 and its feed roller 45, respectively. For the production of flexible sheets, the rotational speeds v₁, v₂ of the feed rollers 43, 45 of the first and second layers 40, 41 are switched between a first speed which is similar to the speed v₄ of the feed roller for transportation and a second speed which is lower than the first speed. The switching is done in an alternating manner, i.e., when the feed roller 43 for the first layer rotates at the first speed, the feed roller 45 of the second layer rotates at the second speed. After some time, the speed v₁ of the feed roller for the first layer 40 ist switched to the second speed and, simultaneously, the speed v₂ of the feed roller 45 for the second layer is switched to the first speed. Therefore, alternating portions subject to high and low stress of the first and second layers 40, 41 are produced. Furthermore, a portion of the first layer 40 subject to high stress and a portion of the second layer 41 subject to low stress will oppose each other when bonded together 47. Handling grips 8 are bonded to the bonded layers 47 at positions determined to become lateral end portions of flexible sheets 2. After bonding the handling grips 8, the ripping knife 50 cuts the bonded layers 47 and the so-produced flexible sheet is ejected.

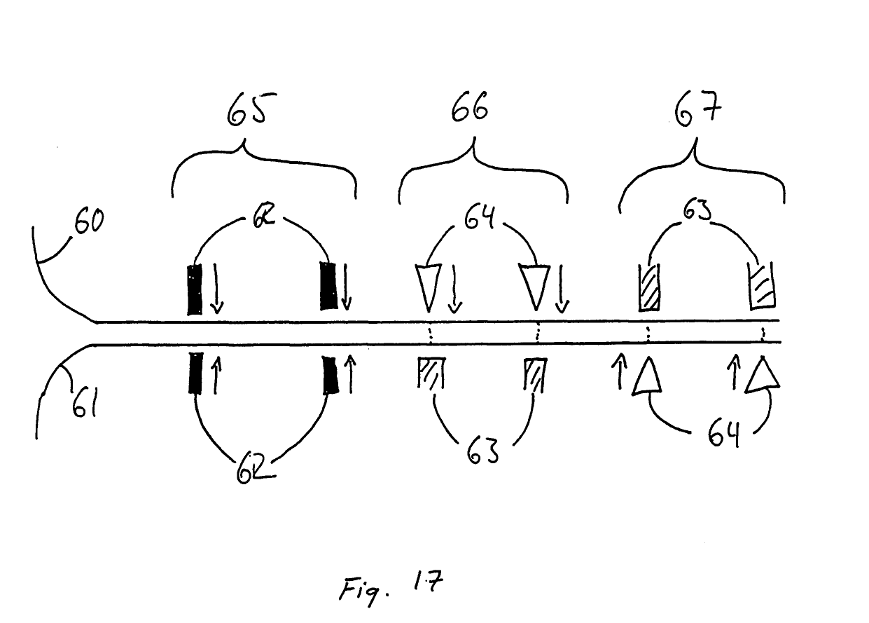

FIG. 16 shows a method according to a further embodiment of the present invention. A first breadth 50 of two layers bonded together is supplied to a feed roller 53. A second breadth 51 of two layers bonded together is supplied to a bonding region 52. The breadths 50, 51 are made of two layers, one of them subject to high stress and one of them subject to low stress. The orientation of the surface of the first breadth 50 subject to high stress is opposite to the orientation of the surface of the second breadth 51 subject to high stress, i.e., in the bonding region 52, the surface of the first breadth 50 subject to high stress will come in touch with the surface of the second breadth 51 subject to low stress or vice versa. Then, the two breadths 50, 51 will be bonded in the bonding region 52 by applying bonding mechanism 56. After bonding, the first breadth 50 will be cut by a first ripping knife 54 and the second breadth 51 will be cut by a second ripping knife 55. After that, the flexible sheet will be ejected by the feed roller 53.

FIG. 17 shows a method according to still another embodiment of the present invention. Again a first breadth 60 of two layers bonded together and a second breadth 61 of two layers bonded together are provided. The breadths 60, 61 are made of two layers, one of them subject to high stress and one of them subject to low stress. The orientation of the surface of the first breadth 60 subject to high stress is opposite to the orientation of the surface of the second breadth 61 subject to high stress, i.e., the surfaces facing each other in the sections 65, 66, 67 of the production process are subject to different stress. In a bonding section 65, the two breadths 60, 61 are bonded together by bonding means 62. The bonding occurs only at defined bonding portions of the breadths and not over the whole of their surface. After the two breadths being bonded, they enter a first cutting section 66. Here, a portion of the first breadth 60 being situated between two adjacent bonding regions is cut out by ripping knifes 64. The opposing part of the second breadth 61 is not cut by the ripping knifes 64. In a second cutting section 67, a portion of the second breadth 61 being situated between two adjacent bonding regions is cut out by ripping knifes 64. The opposing part of the first breadth 60 is not cut by these ripping knifes 64. Only parts of the breadths are cut out which have their counterparts left so that a continous breadth of portions stemming alternately from the first breadth 60 and the second breadth 61 is produced. This resulting breadth can be cut every two portions to obtain flexible sheets.

1. A flexible sheet, comprising two self-winding portions fixed to each other, wherein the winding sense of both portions is the same, but the directions of their angular momenta are opposite to each other.

2. A flexible sheet, comprising two portions fixed to each other, the two portions having a strong tendency to roll up, wherein the rotating vectors of the two portions are opposite to each other.

3. The flexible sheet according to claim 1 or 2, wherein at least one portion of said flexible sheet comprises a prestressed layer

4. The flexible sheet of claim 3, wherein the prestressed layer is subject to high stress and wherein the prestressed layer is bonded to a layer subject to low stress.

5. The flexible sheet of any of the preceeding claims, wherein the layers are made of polyethylene and/or polyester.

6. The flexible sheet of any of the preceeding claims, wherein said flexible sheet further comprises at least one stabilizer.

7. The flexible sheet of any of the preceeding claims, wherein said flexible sheet comprises at least one handling grip for unwinding said flexible sheet, the handling being preferably made out of or covered with a soft material.

8. The flexible sheet of any of the preceeding claims, wherein said flexible sheet is used as a fan banner.

9. The flexible sheet of any of the preceeding claims, wherein detachable thin foils are attached to at least one surface of said flexible sheet.

10. A method for producing a flexible sheet according to any of claims 1 to 9, comprising the following steps:
a) bonding at least two layers, wherein one of the layers is prestressed;
b) cutting the bonded films along a lateral direction to obtain self-winding portions;
c) bonding two self-winding portions, wherein the prestressed surface of one portion faces in a direction opposite to the prestressed surface of the other portion.

11. A method for producing a flexible sheet according to any of claims 1 to 9, comprising the following steps:
a) bonding at least two layers, wherein the first and the second layer comprise portions subject to high and low stress in an alternating manner, and wherein a portion of the first layer subject to high stress is bonded to a portion of the second layer subject to low stress and vice versa;
b) cutting the bonded layers at distal ends along a lateral direction, wherein a sheet to be cut comprises portions subject to high and low stress of the first and second layers.

12. A method for producing a flexible sheet according to any of claims 1 to 9, comprising the following steps:
a) bonding at least two layers, wherein one of the layers is prestressed;
b) supplying two coils of layers bonded according to step a) to a bonding region of a bonding machine, wherein the prestressed surface of a first layer faces a direction opposite to that of the prestressed surface of a second layer,
c) bonding a front portion of the first layer to an end portion of the second layer;
d) cutting the first layer at a distal end of the front portion along a lateral direction and cutting the second layer directly at the bonded end portion;
e) ejecting the obtained flexible sheet from the bonding machine;

13. A method for producing a flexible sheet according to any of claims 1 to 9, comprising the following steps:
a) bonding at least two layers, wherein one of the layers is prestressed;
b) supplying two coils of layers bonded according to step a) to a bonding region of a bonding machine, wherein the prestressed surface of a first layer faces a direction opposite to that of the prestressed surface of a second layer;
c) bonding a bonding portion of the first layer to a bonding portion of the second layer,
d) cutting out between the bonding portions a portion of the first and second layer, respectively, in an alternating manner.

14. A method for producing a flexible sheet according to any of claims 1 to 9, comprising the following steps:
a) providing a prestressed layer,
b) bonding a first sheet of predetermined length to a first surface of the prestressed layer, and bonding a second sheet of predetermined length to a second surface of the prestressed layer, wherein said first sheet and said second sheet are bonded to the prestressed layer in an alternating manner.

15. The method of any of claims 10 to 14, wherein at least one layer comprises polyethylene and/or polyester.

16. The method of any of claims 10 to 14, wherein at least one stabilizer is bonded to the flexible sheet between the self-winding portions.

17. The method of any of claims 10 to 15, wherein at least one handling grip for unwinding said flexible sheet is bonded to a self-winding portion along a lateral direction of the sheet.

18. The method of claim 11, wherein the alternating portions subject to high and low stress of the first and second layers are obtained by controlling the rotational speed of the feed rollers for the first and second layers, respectively.

19. The method of claim 11, wherein at least a third layer is disposed between the first and second layers.
